(19) United States
(12) Patent Application Publication
(10) Pub. No.: US 2015/0292755 A1
(43) Pub. Date: Oct. 15, 2015

(54) REMOVABLE, UNIVERSAL COVER FOR AIR DUCT REGISTER

(71) Applicant: Kenneth Pickett, Edison, NJ (US)

(72) Inventor: Kenneth Pickett, Edison, NJ (US)

(21) Appl. No.: 14/683,348

(22) Filed: Apr. 10, 2015

Related U.S. Application Data
(60) Provisional application No. 61/977,936, filed on Apr. 10, 2014.

(51) Int. Cl. F24F 3/16; B03C 3/017; B01D 46/00

(52) U.S. Cl. CPC F24F 3/166; B01D 46/0038; B01D 46/0023; B03C 3/017; F24F 2003/1689

(57) ABSTRACT

The present disclosure describes a filtration system that can be used with existing air duct registers on a heating ventilation and air conditioning (HVAC) system. The filtration system has a number of layers that limit the contamination of in home air with common pollutants such as mold, bacteria, dander, odors, and the like. The filtration system may also provide for a scent that is dispersed through natural use of the HVAC system.

### CLAIM OF PRIORITY

This application claims priority to U.S. Application 61/977,936 filed on Apr. 10, 2014 the contents of which are herein incorporated by reference in its entirety.

### FIELD OF THE INVENTION

The field of the invention relates to air filters, namely air filter for use with existing heating ventilation and air conditioning units. In particular, the field of the invention relates to air filters that are universally adapted to be used with existing heating ventilation and air conditioning units that employs a combination of meshes, electrostatic filters, and/or scent dispersal units to filter the blown air within a structure.

### BACKGROUND OF THE INVENTION

Most every structure built nowadays contains a central heating ventilation and air conditioning, or HVAC, unit. HVAC units generally provide artificially heated or cooled blown air to the interior confines of various residential, commercial, and industrial buildings. Within HVAC units there are a number of filters which filters the blown air before sending it through the structure. This is important because many outdoor irritants/pollutants such as mold, pollen, smoke, and various other contaminants, particulates, and gases are not desirable to be brought indoors. However, there are a number of downfalls with the current filtration devices associated with HVAC units.

In general, filtration units are located in hard to reach areas. Often this means that the filter are located within the central, or main, portion of the HVAC unit. This requires one must have the ability to access this area in order to change the filter and that they have the proper know-how and tools to complete the job. Even then, because of hassle of changing the filter, HVAC filters are not changed as often as is required to maintain proper airflow and filtration through the HVAC unit.

Further, there are a number of different materials that may comprise such a filter and some filters, while appropriate for one setting, are not appropriate in most cases. Individuals who lack knowledge in the type of filter that should be used with their system may see a sharp decrease in air pressure through the system and thus inefficient heating and/or cooling. Therefore, there is a need to create a filter that can be used with an existing HVAC system and changed quickly and easily. Further, the type of filtration materials should be matched to the setting for which they will be used.

### Review of Related Technology

U.S. Pat. No. 5,525,145 pertains to a filter apparatus that has a rigid housing surrounding a piece of preferably self-charging electrostatic filter material and having a preferably magnetic attachment device for mounting the filter apparatus directly in front of a grill at an end of a cold air return or supply of a forced air system, for a heating and/or air conditioning system. The filter and housing are generally sized so that the frame does not cover any of the openings on the grill over which it is designed to be placed. Decorative openwork is positioned in the front of the filter material to provide an aesthetically pleasing covering of what is considered less than attractive filter material.

U.S. Patent Application 2013/0212991 pertains to an exterior duct filter retainer used in connection with a heating and air conditioning vent, the duct filter retainer including a filter body constructed of a material that is air permeable yet catches particles exiting the vent, the filter body having an attachment assembly connected to the filter body; the attachment assembly being adapted to attach the filter body such that the filter is against and/or in registry with the vent. The filter body can be flat, and the attachment assembly can use a variety of means to attach the filter body in registry with the vent.

U.S. Patent Application 2012/0079945 pertains to an air freshener dispensing register cover which covers an air register and causes the airstream exiting from the air register to be filtered and to pass over a fragrance oil cartridge. The fragrance oil cartridge has diffusion paper saturated with fragrance oil. The components of the register cover are a base, a cartridge holder, a cutter and a top. The base has an opening and is sized to be positioned over an air register. The cartridge holder is attached to the base and holds a fragrance oil cartridge within the airstream exiting from the register. The cartridge holder and cutter cooperate to break a seal within the cartridge to release the fragrance oil within the cartridge. The top covers the base and has openings through which the airstream exits. The amount of fragrance oil remaining within the cartridge may be viewed through a transparent section of the register cover.

Thus, various devices are known in the art. However, their structure and means of operation are substantially different from the present disclosure. The other inventions also fail to solve all the problems taught by the present disclosure. The present invention provides for a base capable of being magnetically or otherwise adhered, either permanently or removably, to existing air registers/ducts. Further, the present invention can be used to completely seal and/or prevent air leaks by employing such a base. In some instances, there is a fragrance/scent dispersal unit that provides for scented, blown air. At least one embodiment of this invention is presented in the drawings below and will be described in more detail herein.

### SUMMARY OF THE INVENTION

As described herein, the present invention and its embodiments describe and teach a filtration device sized to universally adapt to existing supply air registers of heating ventilation and air conditioning systems. The filtration device may be placed on air return registers as well. Additionally, the filtration device can be placed on registers using artificially warmed or cooled air. The filtration device is quickly and easily positioned on the aforementioned existing air registers. This is achieved using the base of the filtration device to adhere to the air duct register. If the air duct register is metal, magnets may be employed and if the duct is not metal, adhesive metal strips, double stick tape, or other adhesive measures and/or coupling measures are used to provide a source of coupling for the filtration device to the register/duct.

In one embodiment, the present invention solves the aforementioned shortcomings by providing a filtration device for an air duct register having a base capable of being magnetically attractive; an inner frame coupled to the base; at least one filtering material; at least one screening material; an outer frame; and wherein the screening material and the filtering material are positioned between the inner frame and the outer frame.

In another embodiment, the filtration device has a base having an outer perimeter and an inner perimeter, wherein the inner perimeter of the base is sized to not restrict the flow of air therethrough; an inner frame coupled to the base having an outer perimeter and an inner perimeter, wherein the inner perimeter of the inner frame is sized to not restrict the flow of air therethrough; an outer frame having an outer perimeter and an inner perimeter, wherein the inner perimeter of the outer frame is sized to not restrict the flow of air therethrough; and a filtration mechanism positioned between the inner frame and the outer frame, the filtration mechanism comprising, at least one filtering material and at least one screening material.

In yet another embodiment of the present invention there is a filtration device for an air duct register having a base having an outer perimeter and an inner perimeter and being capable of being coupled to the air duct register, wherein the inner perimeter of the base is sized to not restrict the flow of air from or into the air duct register, and wherein more than one coupling mechanism and at least one barrier member is disposed along a length on one side of the base, wherein the at least one barrier member is covers a distance the between the more than one coupling mechanism; an inner frame coupled to the base having an outer perimeter and an inner perimeter, wherein the inner perimeter of the inner frame is sized to not restrict the flow of air from or into the air duct register;

an outer frame having an outer perimeter and an inner perimeter, wherein the inner perimeter of the outer frame is sized to not restrict the flow of air from or into the air duct register; a filtration mechanism positioned between the inner frame and the outer frame, the filtration mechanism comprising a mesh screen and an electrostatic filter, wherein the filtration mechanism is capable of dispersing a scent.

The filtration mechanism in some embodiments comprises a screening material and a filtering material to efficiently remove most pollutants such as allergens, bacteria, odors, and the like from the interiorly circulated air. Due to the location and simplicity in replacing the unit, users will be more apt to readily change the filtration device thereby keeping the air within the structure free of pollutants. In some cases, a scent dispersal apparatus may be used to provide the blown air with a pleasant scent that further provides a feeling of freshness and cleanliness.

In general, the present invention succeeds in conferring the following, and others not mentioned, benefits and objectives.

It is an object of the present invention to provide a filtration device that fits securely over existing air registers of a HVAC system.

It is an object of the present invention to provide a filtration device that filters a majority of pollutants from permeating the interior of a building.

It is an object of the present invention to provide a filtration device that is capable of dispersing a scent throughout the interior of a structure.

It is another object of the present invention to provide a filtration device that is universal in shape and design.

It is another object of the present invention to provide a filtration device that provides an easily accessible and interchangeable filter for an HVAC system.

It is another object of the present invention to provide a filtration device that saves the consumer time and money associated with the maintenance of their HVAC system.

### BRIEF DESCRIPTION OF THE DRAWINGS

FIG. 1 is an exploded view showing the interrelationship between the various components of the present invention.

FIG. 2 is a perspective view of the present invention demonstrating its placement over an existing air register.

FIG. 3 is a front view of the present invention when placed as intended over an existing air register.

FIG. 4 is a perspective view of another embodiment of the present invention showing its placement over an existing air register.

FIG. 5 is a back view of another embodiment of the present invention.

FIG. 6 is a front view of the embodiment shown in FIG. 5.

FIG. 7 is a back view of another embodiment of the present invention.

FIG. 8 is a front view of the embodiment shown in FIG. 6.

### DETAILED DESCRIPTION OF THE DRAWINGS

The preferred embodiments of the present invention will now be described with reference to the drawings. Identical elements in the various figures are identified, as far as possible, with the same reference numerals.

Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

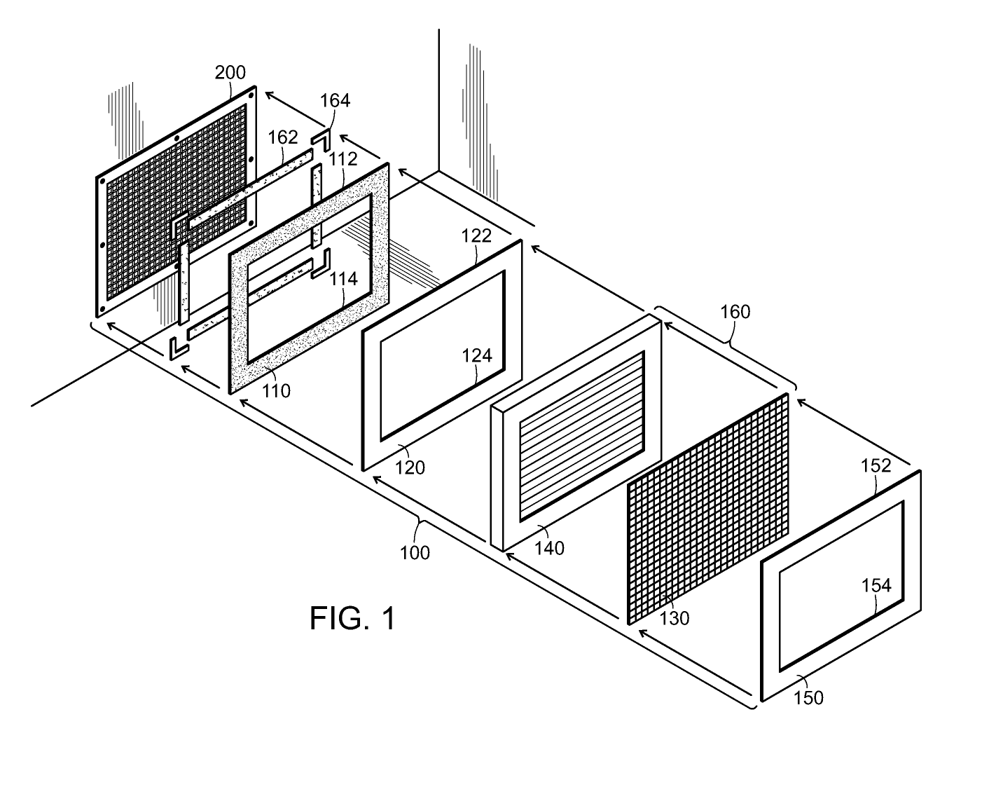

Referring to FIG. 1, there is an exploded view of the various components of the present invention. Generally shown is an existing HVAC air duct register 200, which may pass through a floor, wall, or ceiling, or other component of a structure. The air duct register 200 is typically adhered to the surface with a number of screws or other suitable coupling mechanism(s) and has a grated structure which the blown air passes through on its way from the duct work to the interior building space. In some instances, air is drawn into the HVAC air duct register 200 in the event that the duct acts as a return for the system. The present invention and its embodiments relate to a filtration device 100 that is placed over the air duct register (either forced air or return) 200 present within a structure.

The filtration device 100 has a number of components arranged in “layers.” The base 110 may be adhered to the air duct register by a variety of coupling mechanisms including magnetic materials, double sided adhesives, single sided adhesives, epoxies, resins, and the like or any combination thereof. In some embodiments, the base 110 is optional and only an inner frame and outer frame may comprise the exterior structure or framing of the device 100. The coupling mechanisms are preferably arranged to allow not interfere mounting mechanism 195 which holds the air duct register 200 to the wall or other structure.

The coupling mechanism may be permanent or removable depending on the desired usage. As noted, in some cases, the air duct register 200 is not comprised of metal materials and the coupling mechanism must be chosen based on the suitability for the particular materials. Here, magnetic material 164 is shown. A barrier member 162 comprising a barrier to prevent forced or blown air from escaping from between the air duct register 200 and the filtration device 100 is disposed between the magnetic material 164 or other suitable coupling mechanism.

The base 110 is shaped in some instances to provide tabs. These tabs are used to facilitate the placement and removal of the filtration device 100. The base 110 has a shape and size that allow it to fully cover the perimeter of the air duct register 200. This limits the gaps present between the two structures and prevents unfiltered air from being passed into a particular room or area of a building. There is a base inner perimeter 114 and a base outer perimeter 112. The outer perimeter 112 as mentioned is sized to match that of the air duct register 200 and form a seamless bond between the two surfaces. The base inner perimeter 114 is sized so that air flow is not restricted or impeded by the base 110.

The base 110 is coupled to the inner frame 120 of the filtration device 100. The inner frame 120 has an inner frame outer perimeter 122 and an inner frame inner perimeter 124. The inner frame outer perimeter 122 is sized to align appropriately with the base 110. The inner frame inner perimeter 124 is sized to not impede or restrict the air flow stemming from the air duct register 200. The outer frame 150 bears a generally similar, and in some cases the same, size and shape to the inner frame 120. Thus, the inner perimeters and outer perimeters of the outer frame 150 and inner frame 120 bear near identical dimensions and are sized and shaped as to not impede or restrict the flow of air from the air duct register 200.

A filtration mechanism 160 is situated between the inner frame 120 and the outer frame 150 of the filtration device 100. The filtration mechanism 160 generally has at least one screening material 130 and at least one filtering material 140. The number of and exact type of screening material 130 and filtering material 140 may vary depending on the intended usage (i.e. residential, commercial, industrial). Hence, there may be multiple layers comprising each of the filtering material 140 and the screening material 130 all of which may be the same or different from one another.

The screening material 130 is used to screen large particles that may prematurely clog the filtering material 140 thereby reducing the amount of air flow or the ability of the filtering material 140 to efficiently clean the blown air. The screening material 130 is typically a layer of mesh. Multiple layers of mesh may be used to reduce the size of the openings in the mesh without obstructing the free flow of air. The openings in the screening material 130 may vary but be should smaller than or equal to about 10 mm and more preferably less than 5 mm and most preferably less than 1 mm. If there are multiple layers of the screening material 130, each layer may have different sized or the same sized openings. The composition of the screening material 130 may vary but is preferably metallic in nature and contains compounds selected for their durability and resistance to corrosion. In some instances, particular screening materials may be selected for their anti-microbial properties (i.e. copper) and other desired benefits.

The filtering material 140 is preferably a filter having electrostatic properties. The filtering material 140 may be selected depending on the environment for which the blown air will be filtered. The minimum efficiency reporting value, or Mery rating, is a scale used by the American Society of Heating, Refrigeration, and Air Conditioning Engineers (ASHRAE) to place filters used for such purposes in a scaled system based on performance. The Mery rating places filters on a scale of 1-16 with a ranking of 16 filtering out more than 95% of particulates. Thus, the particular filtering material 140 may be selected based on these or other industry developed and accepted standards for filtration devices depending on placements such as a home, office, warehouse, hospital, laboratory, and the like, or some combination thereof.

In some instances, multiple filtering materials 140 may be used in conjunction with one another. The filtering material 140 may be positioned on the outside (relative to the placement of the filtration device 100) of the screening material 130, inside of the screening material 130, or positioned on both the inside and the outside of the screening material 130.

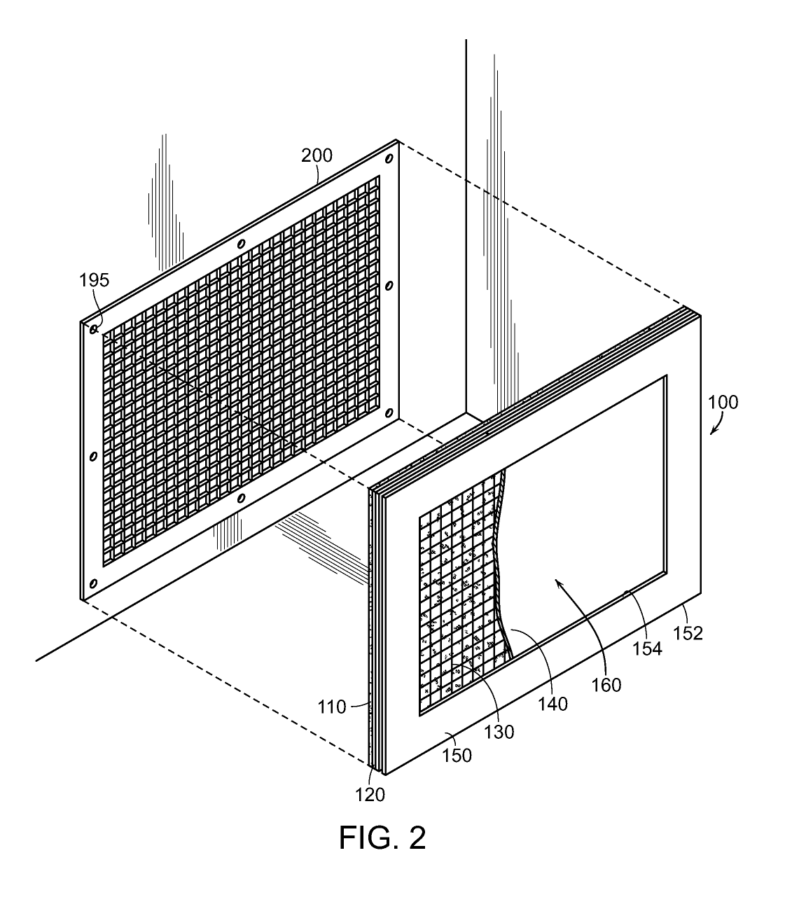

In FIG. 2, one embodiment of the filtration device 100 is shown as assembled and positioned for adherence, either permanent or temporary, to the air duct register 200. The inner frame 120 and the outer frame 150 are positioned such that the outer and inner perimeters of each align with one another. The base 110 is coupled to the inner frame 120. The base 110 may be coupled to the inner frame 120 either mechanically (rivets, screws, etc.) or chemically (epoxies, adhesives, etc.) or other suitable removable mechanisms. The base 110 is shown having generally the same dimensions as the inner frame 120 and the outer frame 150.

The filtration mechanism 160 is shown with a portion of the filtering material 140 removed to show the screening material 130 underneath. In other instances, the screening material 130 may be positioned “outside” relative to the filtering mechanism 130. The outer frame outer perimeter 152 and the outer frame inner perimeter 154 border the outer side of the filtration mechanism 160. The base 110 is adhered directly to the existing air duct register 200 and its exact placement can be adjusted thereafter using the tabs if applicable. The coupling mechanisms as described should have their placement selected to effectively surround the mounting mechanism (i.e. screws) which hold the air duct register 200 to the wall or other structure. This enables the filtration mechanism 100 to lie flush with the air duct register 200.

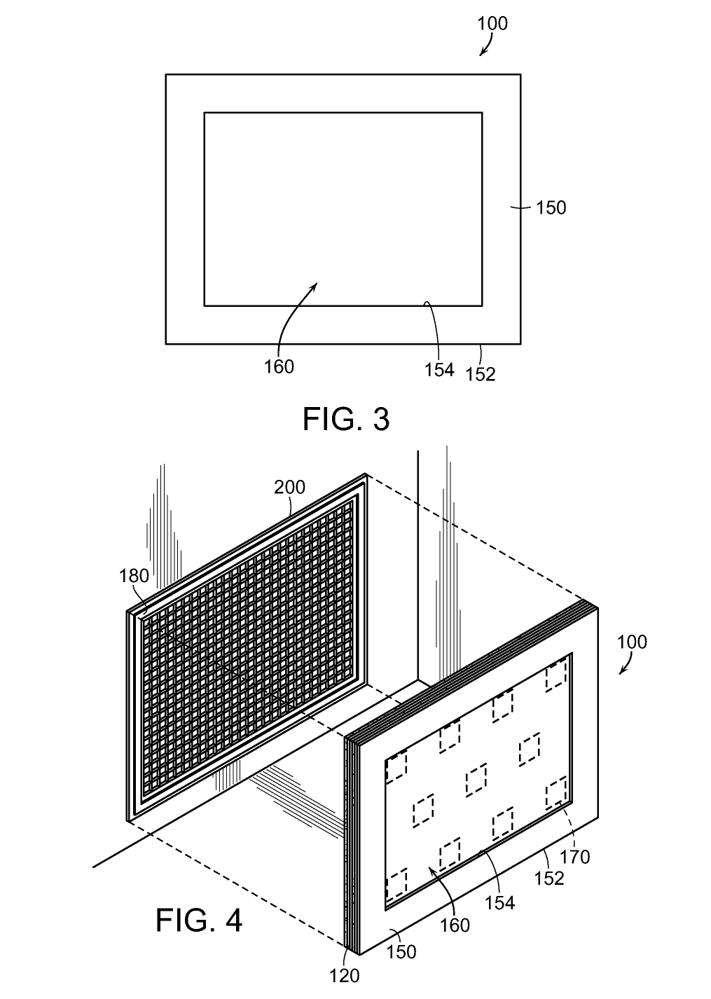

The filtration device 100, as shown in FIG. 3, has been placed on an existing air duct register 200. From this view, visible are the outer frame 150 and the outer frame outer perimeter 152 and the outer frame inner perimeter 154. Visible within the confines of the outer frame inner perimeter 154 is the filtration mechanism 160.

Another embodiment of the filtration device 100 is shown in FIG. 4. Much of the structure of the filtration device 100 parallels that of the other embodiment(s) described herein. The outer frame 150 is shown having an outer frame inner perimeter 154 and an outer frame outer perimeter 152. Between the inner frame 120 and the outer frame 150 is the filtration mechanism 160. However, in this instance, there is a scent dispersal apparatus 170 that is used to provide a particular scent(s) to the filtered blown air.

The scent dispersal apparatus 170 may take a number of forms that enable the scent to be carried by the blown air. In some instances, the scent in impregnated in the fibers of the filtering material 140, whereas in some instances it may be preferable to have the scent dispersal apparatus 170 comprise a wholly separate unit. For example, there may be a particular compartment or opening where scent can be periodically applied for dispersal into the air. Even yet, the scent dispersal apparatus 170 may be a separate layer positioned between or outside of the inner frame 120 and outer frame 150. In some instances, the scent dispersal apparatus 170 is a containment or housing within the filtration device 100 that allows scent to be impregnated into the air. The scent dispersal apparatus 170 may be removable or permanent and may be used or have the scent changed and/or replaced as needed.

Additionally, this embodiment provides for magnetic adhesive strips 180 to be used in conjunction with the filtration device 100. In some instances, the air duct register 200 comprises a non-metallic and/or non-magnetic material. Thus, the base 110 of the filtration device 100 will not adhere to the air duct register 200 in this scenario. The application of the magnetic adhesive strips 180 to the air duct register 200 or other base 110 provides the magnetic surface necessary for placement of the filtration device 100.

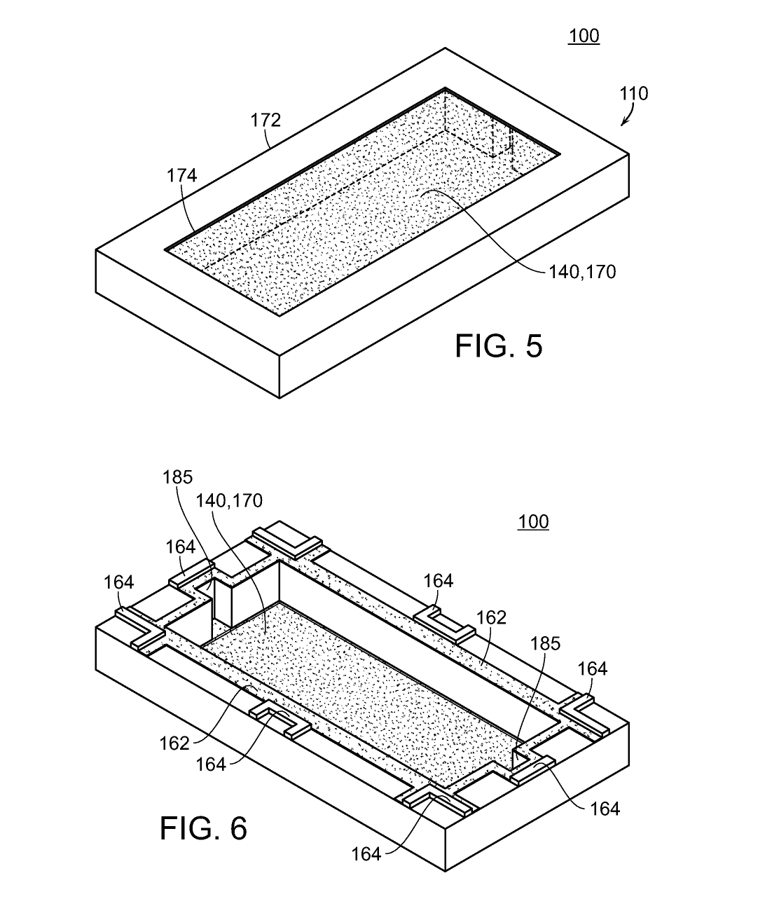

Referring to FIGS. 5 and 6, there is another embodiment of the present invention. Here, the filtration device 100 is designed and intended to be positioned on an air return duct register. The filtration device 100 has a base 110 having an outer perimeter 172 and an inner perimeter 174. A filtering material 140 and optional scent dispersal 170 is disposed across an opening in the base 110 that allows air to pass “inwards” therethrough into the HVAC system. On the underside of the base 110, there is a magnetic material 164. The magnetic material 164 may be permanently or removably coupled to the base. The magnetic material 164 may be selected from any number of materials that display magnetic properties. The filtering material 140 is generally that of which is described elsewhere herein.

Since the magnetic material 164 may be raised slightly off the surface of the base 110, a barrier member 162 is disposed along the inner perimeter 174 in between the lengths of magnetic material 164. The barrier member 162 may be any material that is capable of preventing the escape of air from between an air duct register or similar structure and the base 110 and include but not be limited to fabrics, meshes, rubbers, silicones, and the like or any combination thereof.

The base 110 further provides cut outs 185 along at least one and potentially more lateral edges forming the inner perimeter 172. These cutouts 185 may be of varying shape and are intended to accommodate structure that may or may not be present on the air duct register, register, or the like. The cutouts 185 may be formed through the entirety of the base or may be formed through only a portion of the base. For example, it may be desired to have control of the directional air flow using a vent control mechanism. Thus, the control mechanism may be able to be accessed through the cutout 185 in the base. In such a scenario, adequate steps and structure should be contemplated to prevent the escape of air through the cutout 185.

In another example, such a mechanism may not need to be manipulated and therefore the cutout 185 enables the vent control mechanism or other structure to be covered while permitting the filtration device 100 to remain flush with the air duct register, register, or the like. The cut outs 185 may be arranged in any number, shape, size, and configuration necessary to enable either operation of the air duct register or use of the filtration mechanism 100.

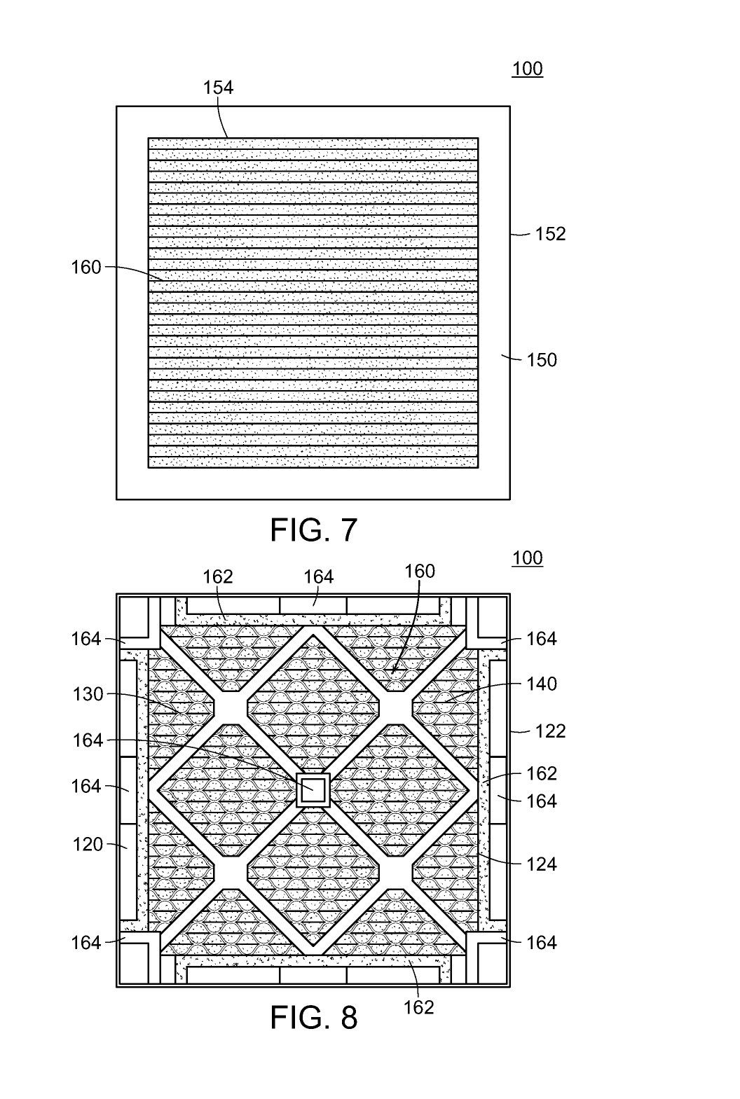

Referring now to FIGS. 7 and 8, there is another embodiment of the present invention which is generally design to be positioned over an air exit or forced air duct register of an HVAC system, although such an embodiment may be used on return or other ducts as well. There is an outer frame 150 having an outer perimeter 152 and an inner perimeter 154. A filtration mechanism 160 covers an opening created by the inner perimeter 154.

The inner frame 120 has an outer perimeter 122 and an inner perimeter 124. Lengths of magnetic material 164 are adhered thereto. The magnetic material 164 may be permanently and/or removably coupled to the inner frame 120. The exact arrangement and configuration of the magnetic material 164 may vary. A barrier mechanism 162, as described above, is disposed along a length of the inner frame 120 in between the lengths of magnetic material 164.

In some embodiments, there is an adhesive applied to the frame to cause the filtration device 100 to adhere to an air duct register, register, or the like. The adhesive may be permanent or removable and may be single or double sided such as a double sided tape.

The filtration mechanism 160 may be comprised of at least one layer of a screening material 130 and at least one layer of a filtering material 140. The screening material 130 layer(s) and the filtering material 140 layer(s) may be arranged in varying configurations and varying numbers. For example, there may be multiple screening material 130 layers which may be the same or different as any of the other layers. The same tenet holds true for the filtering material 140 layers.

Generally the filtration device 100 described by FIGS. 1-8 is sized to fit and securely cover any existing air duct register 200 including returns. Thus, the filtration device 100 is typically between about 7.6 cm (3 inches) to about 114 cm (45 inches) in width and is preferably about 29 cm (11.5 inches) in width. The filtration device 100 may vary between about 5 cm (2 inches) and about 114 cm (45 inches) in height, while being preferably about 22 cm (8.75 inches) in height. The exact dimensions for the inner and outer perimeters will vary depending on the air duct register 200 in question and the sizing requirements based thereon.

The outer frame 150 and the inner frame 120 are shown generally as “sandwiching” the filtration mechanism 160. However, it should be appreciated that the structure of the frames may be such that the filtration mechanism 160 is housed in a particular structure (such as a channel) to further hold it in place and prevent unfiltered air from escaping the filtration device 100. In some cases, the frames (inner and outer) may be removable or separable in order to replace the filtration mechanism 160 contained therein. However, due to the ease of access and low cost associated with the filtration device 100 it is preferable that the filtration mechanism 160 is not removable and that an old filtration device 100 is simply removed and thrown away in lieu of a new device 100.

The exact specifications will vary depending on whether the filtration device is used on a blown air duct register 200 or return. For example, the screening material 130 may be placed on the outside, or opposite that a blown air duct register 200, when use on a return. Other components, such as fragrance, may simply not be necessary with an air return. Thus, the present invention contemplates and covers these variances without deviating from the inventive concept to provide for such applications.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A filtration device comprising:
an inner frame;
at least one filtering material;
at least one screening material;
an outer frame; and
wherein the screening material and the filtering material are positioned between the inner frame and the outer frame.

2. The filtration device of claim 1 further comprising a base coupled to the inner frame and to an air duct register using a double sided adhesive.

3. The filtration device of claim 1 further comprising a scent dispersal apparatus.

4. The filtration device of claim 1 wherein the at least one filtering material is an electrostatic filter.

5. The filtration device of claim 3 wherein the scent dispersal apparatus is removable and/or replaceable.

6. The filtration device of claim 1 wherein the base, inner frame, and outer frame have an inner perimeter that is sized to not restrict air flow to or from an air duct register.

7. A filtration device for an air duct register comprising:
a base having an outer perimeter and an inner perimeter,
wherein the inner perimeter of the base is sized to not restrict the flow of air therethrough;
an inner frame coupled to the base having an outer perimeter and an inner perimeter,
wherein the inner perimeter of the inner frame is sized to not restrict the flow of air therethrough;
an outer frame having an outer perimeter and an inner perimeter,
wherein the inner perimeter of the outer frame is sized to not restrict the flow of air therethrough; and
a filtration mechanism positioned between the inner frame and the outer frame, the filtration mechanism comprising,
at least one filtering material and at least one screening material.

8. The filtration device of claim 7 further comprising a scent dispersal apparatus.

9. The filtration device of claim 7 wherein the at least one filtering material is an electrostatic filter and the at least one screening material is a mesh screen.

10. The filtration device of claim 9 wherein the mesh screen and the electrostatic filter may be positioned on either side of one another.

11. The filtration device of claim 7 wherein the filtration mechanism is capable of treating both artificially heated and cooled air.

12. The filtration device of claim 7 wherein the mesh screen has openings smaller than or equal to about 5 mm and more preferably smaller than or equal to about 1 mm.

13. The filtration device of claim 7 wherein the inner frame and outer frame have approximately the same dimensions.

14. A filtration device for an air duct register comprising:
a base having an outer perimeter and an inner perimeter and being capable of being coupled to the air duct register,
wherein the inner perimeter of the base is sized to not restrict the flow of air from or into the air duct register, and
wherein more than one coupling mechanisms and at least one barrier member is disposed along a length on one side of the base,
wherein the at least one barrier member covers a distance between the more than one coupling mechanisms;
an inner frame coupled to the base having an outer perimeter and an inner perimeter,
wherein the inner perimeter of the inner frame is sized to not restrict the flow of air from or into the air duct register;
an outer frame having an outer perimeter and an inner perimeter,
wherein the inner perimeter of the outer frame is sized to not restrict the flow of air from or into the air duct register;
a filtration mechanism positioned between the inner frame and the outer frame, the filtration mechanism comprising a mesh screen and an electrostatic filter,
wherein the filtration mechanism is capable of dispersing a scent.

15. The filtration device of claim 14 wherein the scent dispersal apparatus is capable of dispersing at least one scent containing compound.

16. The filtration device of claim 14 wherein the coupling mechanism comprises adhesive strips.

17. The filtration device of claim 14 wherein the filtration mechanism is sized to completely cover the air duct register.

18. The filtration device of claim 14 wherein the base has at least one tab protruding therefrom.

19. The filtration device of claim 14 wherein the coupling mechanism is a length of magnetically attractive material.

20. The filtration device of claim 14 wherein the inner perimeter of the base, the inner frame, and the outer frame all have the same dimensions.
